(19) United States
(12) Patent Application Publication
(10) Pub. No.: US 2007/0105968 A1
(43) Pub. Date: May 10, 2007

(54) Multi-density flexible foam

(76) Inventors: Kenneth Warnshuis, Adrian, MI (US); Victor Gandara, Adrian, MI (US); Felipe R. Terrones, Adrian, MI (US)

Correspondence Address: Miller, Canfield, Paddock and Stone P.L.C.;c/o Robert Kelley Roth, Suite 2500, 150 West Jefferson Ave, Detroit, MI, 48226, US

(21) Appl. No.: 11/272,358

(22) Filed: Nov. 10, 2005

(51) Int. Cl. C08J 9/16

(52) U.S. Cl. 521/56

(57) ABSTRACT

A multi-density flexible foam is disclosed which comprises a polyol mixture, an isocyanate mixture combined with the polyol mixture in a ratio of about 20 to 100 parts by weight of the polyol mixture, and expandable beads added in an amount of about 10 to 150 parts per weight of the polyol mixture, wherein the polyol mixture and isocyanate mixture react together to form a cured polyurethane foam.

### FIELD OF THE INVENTION

This invention relates to improvements in multi-density foams, and more particularly to improvements in multi-density foams suitable for use in formation of foam objects.

### BACKGROUND OF THE INVENTION

Flexible foam objects are used in many applications, including furniture, bedding, steering wheels, instrument panels, console box lids and glove box lids, seating, armrests and headrests, etc. Flexible foams comprise a range of foams, including integral skin foams, slab stock (used extensively in furniture foams), molded flexible foams, and viscoelastic foams (used in bedding). Generally these foams are not structural members and they resiliently yield to pressure. Flexible foams generally have an open cell structure, whereas rigid foams have a closed cell structure with discrete foam cells.

One example of a use of flexible foams is headrests, which have been used in motor vehicles for many years. The flexible foam headrest provides both a convenient place to rest an operator's head and also provides protection in the event of sudden changes in acceleration of the motor vehicle. Headrests also often are adjustably mounted to a seat to provide comfort adjustment. Generally, such headrests include cloth covered headrests and integral skin foam headrests. With cloth covered headrests, a flexible foam or cushion like interior is shrouded by a cloth. Integral skin foam headrests have an exterior integral skin region with a low degree of foaming (often with a urethane paint applied to the molded part) and an interior region having a high degree of foaming. Known flexible foam headrests are subject to competing design constraints. On the one hand, it is desirable to make the foam headrest comfortable for the occupant. On the other hand, it is desirable to increase the stiffness of the headrest to reduce a whiplash effect during sudden changes in acceleration of a motor vehicle. It would be highly desirable to have an improved flexible foam object with optimized stiffness characteristics.

The flexible foam is typically polyurethane foam formed from a reaction of a polyol and an isocyanate. While a wide varieties of isocyanates can be used to make polyurethane foam, the most common isocyanates are toluene diisocyanate (TDI) and polymeric isocyanate (MDI). A broad range of properties and characteristics have been made for polyurethanes (from rigid foams to flexible foams) principally by varying components of the polyol mixtures. For flexible polyurethane foams, long chain triols and water may be used as components of the polyol mixture. When these types of polyols are reacted with isocyanates, wide-meshed elastic networks of ruptured cell walls are formed, creating a web of elastic strands. Also, cross linking takes place both chemically and physically. If a rigid foam is desired, alternate polyol mixtures must be used to create the desired characteristics.

U.S. Pat. No. 6,727,290 to Roth discloses a rigid polyurethane formed from a mixture of a polyol and an isocyanate. A small amount of expandable beads are added to the mixture before it cures. The beads expand and take up some of the space which would otherwise be occupied with polyurethane. However, such rigid polyurethanes have structural properties where they are designed to withstand relatively large amounts of loading (e.g., rigid polyurethanes may be used as plastic pallets). To maintain these properties, rigid foams require relatively large amounts of isocyanates and relatively low amounts of beads, to preserve density and maintain rigid foam impact durability. It would be highly desirable to provide a flexible foam with enhanced ease of manufacturability.

### SUMMARY OF THE INVENTION

In accordance with a first aspect, a multi-density flexible foam is disclosed which comprises a polyol mixture, an isocyanate mixture combined with the polyol mixture in a ratio of about 20 to 100 parts by weight of the polyol mixture, and expandable beads added in an amount of about 10 to 150 parts per weight of the polyol mixture, wherein the polyol mixture and isocyanate mixture react together to form a cured polyurethane foam.

From the foregoing disclosure and the following more detailed description of various preferred embodiments it will be apparent to those skilled in the art that the present invention provides a significant advance in the technology of flexible foam parts. Particularly significant in this regard is the potential the invention affords for providing a high quality flexible foam part with varying density. Additional features and advantages of various preferred embodiments will be better understood in view of the detailed description provided below.

### DETAILED DESCRIPTION OF CERTAIN PREFERRED EMBODIMENTS

It will be apparent to those skilled in the art, that is, to those who have knowledge or experience in this area of technology, that many uses and design variations are possible for the multi-density flexible foam disclosed here. The following detailed discussion of various alternative and preferred features and embodiments will illustrate the general principles of the invention with reference to a headrest suitable for use in automotive applications. Other embodiments suitable for other applications (such as slab stock for bedding and other furniture, viscoelastic foams, other foams for consumer and automotive products, etc.) will be readily apparent to those skilled in the art given the benefit of this disclosure.

Broadly, manufacture of a flexible polyurethane part such as an automotive headrest involves combining a reactive two component mixture in a mold. The mold would typically have an upper half and a lower half. The halves of the mold can be closed together and cooperate to define a mold cavity which corresponds to the shape of the part to be molded. A cured polyurethane foam part is formed by reaction of two components: a polyol mixture containing at least one polyol and an isocyanate mixture comprising isocyanate are introduced together into the mold cavity. The components react exothermically and quickly foam to fill the mold cavity. These two components can be combined together in an open pour process or in a closed mold process. Optionally a urethane paint may be applied to mold prior to reacting the two components together. The polyol mixture and isocyanate mixture react behind the paint to form an integral skin foam part.

Typically the polyol mixture comprises a polyol such as a triol, surfactants (to help reduce surface tension of the fluid), catalysts (to accelerate the reaction) and sometimes water and/or a blowing agent. Typically the isocyanate mixture comprises an isocyanate such as TDI or MDI. For flexible foam polyurethanes, if 100 parts by weight of a polyol mixture are used, typically 20-100 parts by weight of the isocyanate mixture is used.

In accordance with a highly advantageous feature, it has been found that a multi-density foam material is formed from addition of expandable beads to the flexible foam polyurethanes formed from reaction of a polyol with an isocyanate. As the reaction takes place, heat is generated. This heat causes gas trapped in the expandable beads to be released, expanding the volume of the bead. The mold cavity is cooler near its edges. Advantageously, it has been found that the polymer beads expand more in the center of the flexible foam polyurethane part formed, and less near the edges of the part (near the mold halves). The result is that the cured polyurethane foam has a center with a first density, and an edge with a second density less than the first density. A cross section through such a part shows a matrix of cured polyurethane foam with large beads in the center and smaller, less expanded beads around the periphery of the part. When the part is a headrest, the effect is a soft exterior which is comfortable and a harder interior which helps reduce the chances of whiplash in some instances.

Also, parts made with the current invention typically have an Indentation Force Deflection (IFD), which is a measure of the load bearing capacity of flexible polyurethane foam which is greater near the center of the part than at the edge. IFD is generally measured as the force (in pounds) required to compress a 50 square inch circular indentor foot into a four inch thick sample no smaller than 24 inches square, to a stated percentage of the sample's initial height. Common IFD values for flexible foam polyurethane parts are generated at 25 and 65 percent of initial height.

Further, when the expandable beads comprise a material having a greater density (even when expanded) than the polyurethane foam by itself, the overall density of the cured polyurethane foam with the beads is increased. Materials that are suitable for use as the expandable beads comprise polymers such as polypropylenes, polyolefins, polystyrenes, polyethylenes, etc. Other materials suitable for use as expandable beads will be readily apparent to those skilled in the art given the benefit of this disclosure. Preferably unexpanded expandable beads having a diameter of about 0.1 to 6 mm may be used, most preferably about 0.4 mm. Also, it has been found that a preferably range of such expandable beads is 0.1 to 1.5 parts by weight of the polyol mixture. Use of this range of amount of beads with polyol mixtures and isocyanate mixtures has been found to create multi-density cured polyurethane foams. Other two component polyol/isocyanate mixtures which work with the expandable beads discussed herein will be readily apparent to those skilled in the art given the benefit of this disclosure. As the reaction between the polyol mixture and the isocyanate mixture is fairly rapid, it is preferably to premix the expandable beads with either the polyol mixture or the isocyanate mixture, or both. Where beads are added to both mixtures, larger amounts of bead may be used, as much as 1.2-1.5 parts by weight of the polyol mixture. For example, 0.75 parts may be added to the polyol mixture and 0.75 parts added to the isocyanate mixture.

### EXAMPLE 1

A integral skin foam flexible polyurethane part can be made by applying a polyurethane paint to a mold, and then injecting two reactants; the first reactant is 100 parts by weight of a polyol mixture (comprising largely a polyol) and 50 parts by weight of polypropylene beads, or 0.5 parts by weight of the polyol, average diameter unexpanded: 0.4 mm. The second reactant is an isocyanate mixture, comprising largely an isocyanate, 40 parts by weight, or 0.4 parts by weight of the polyol. Typically little or no water is used for such integral skin flexible foam parts. Water substitutes may be used as a blowing agent, e.g., ethylene glycol, carbamides, or other commercially available blowing agents, if needed. The polyols and isocyanates can be supplied as system (where one supplier provides a premixed polyol mixture containing polyol and some other ingredients, and separately a premixed isocyanate mixture, most typically comprising largely isocyanate) by any one of numerous sources, including the Bayflex system from Bayer. Although 50 parts by weight is most preferred, smaller amounts such as 10-20 parts have also been found to produce acceptable multi-density parts.

### EXAMPLE 2

A flexible foam polyurethane part without an integral skin is formed from combining a first mixture and a second mixture. The first mixture comprises a polyol mixture comprising 100 parts by weight of a polyol mixture, 4.5 parts by weight water, mixed with 100 parts by weight polypropylene beads, average diameter (unexpanded) of about 0.4 mm. The second mixture comprises an isocyanate mixture of about 75 parts by weight, mixed with the first mixture in a mold. The reaction is exothermic and foam generating, and causes the foam to expand (both polyurethane and expandable beads) to fill the mold. These polyol mixtures and isocyanate mixtures can be supplied as systems can be provided by any one of numerous sources, including the Bayfit system from Bayer or the Rubiflex/Rubinate system supplied by Huntsman. The polyol mixture and isocyanate mixture may be blended together at the site of production of the foam part.

The embodiments discussed were chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A multi-density foam material comprising, in combination:
a polyol mixture;
an isocyanate mixture combined with the polyol mixture in a ratio of about 0.2 to 1.0 parts by weight of the polyol mixture; and
expandable beads added in an amount of about 0.1 to 1.5 parts per weight of the polyol mixture;
wherein the polyol mixture and isocyanate mixture react together to form a cured flexible polyurethane foam.

2. The multi-density foam material of claim 1 wherein the polyol mixture comprises at least one polyol and water.

3. The multi-density foam material of claim 1 wherein the polyol mixture and the isocyanate mixture react exothermically to form the cured flexible polyurethane foam, and heat generated from the reaction causes the expandable beads to at least partially expand.

4. The multi-density foam material of claim 3 wherein the cured polyurethane foam has a center with a first density, and an edge with a second density less than the first density.

5. The multi-density foam material of claim 1 wherein the expandable beads have, when unexpanded, an average diameter of about 0.4 mm.

6. The multi-density foam material of claim 1 wherein the beads are added to one of the polyol mixture and the isocyanate mixture prior to mixing the polyol mixture and the isocyanate mixture together.

7. A multi-density foam material comprising, in combination:
a polyol mixture;
an isocyanate mixture, added to the polyol mixture; and
expandable beads in an amount of about 0.2 to 1.5 parts per weight of the polyol mixture.

8. The multi-density foam material of claim 7 wherein the expandable beads comprise one of an expandable polypropylene, an expandable polyolefin, an expandable polystyrene, and an expandable polyethylene.
